(19) United States
(12) Patent Application Publication
(10) Pub. No.: US 2014/0062960 A1
(43) Pub. Date: Mar. 6, 2014

(54) DISPLAY APPARATUS AND METHOD OF RECOGNIZING AIR TOUCH USING THE SAME AND METHOD OF DISPLAYING THREE-DIMENSIONAL IMAGE USING THE SAME

(71) Applicant: SAMSUNG DISPLAY CO., LTD., Yongin-City (KR)

(72) Inventors: Ji-Woong KIM, Suwon-si (KR); Bo-Ram KIM, Seoul (KR); Jong-Yoon LEE, Ansan-si (KR); Su-Bin PARK, Incheon (KR)

(73) Assignee: SAMSUNG DISPLAY CO., LTD., Yongin-City (KR)

(21) Appl. No.: 13/742,216

(22) Filed: Jan. 15, 2013

(30) Foreign Application Priority Data
Aug. 30, 2012 (KR) 10-2012-0095901

(51) Int. Cl. G06F 3/042; H04N 13/04

(52) U.S. Cl. CPC G06F 3/042; H04N 13/047
USPC 345/175; 345/697

(57) ABSTRACT

A display apparatus includes a display panel, a first camera and a second camera disposed adjacent to the display panel; and a distance determining part determining a position of a body portion of a viewer and a distance of the body portion of the viewer from the display panel based on a first image of the first camera and a second image of the second camera.

### CROSS-REFERENCE TO RELATED APPLICATION

This application claims priority to Korean Patent Application No. 10-2012-0095901, filed on Aug. 30, 2012, and all the benefits accruing therefrom under 35 U.S.C. §119, the contents of which are herein incorporated by reference in their entireties.

### BACKGROUND OF THE INVENTION

1. Field of the Invention

Exemplary embodiments of the present invention relate to a display apparatus, a method of recognizing an air touch using the display apparatus and a method of displaying a three-dimensional (“3D”) image using the display apparatus. More particularly, exemplary embodiments of the present invention relate to a display apparatus determining a distance of a viewer from the display apparatus, a method of recognizing an air touch using the display apparatus and a method of displaying a 3D image using the display apparatus.

2. Description of the Related Art

Recently, a display apparatus tracking a position of a body portion and using the position of the body portion has been developed. For example, the display apparatus may determine a position of eyes of a viewer. Alternatively, the display apparatus may determine a position of a face of the viewer.

In a conventional body tracking algorithm, the display apparatus determines a position of the body portion using only two-dimensional (“2D”) information so that a target body portion may not be tracked accurately when many candidates of the body portions are existed.

In addition, when a plurality of viewers simultaneously uses the display apparatus, the display apparatus may not determine distances of the viewers from the display apparatus. Thus, the display apparatus may not properly track the body portion of a main viewer, who is closer to the display apparatus.

For example, when the body portion of a sub viewer who is farther from the display apparatus is greater than the body portion of the main viewer who is closer to the display apparatus, the display apparatus may determine the sub viewer as the main viewer.

Furthermore, a region of interest may not be set in the conventional display apparatus so that unnecessary resource consumption for a body tracking may occur.

### BRIEF SUMMARY OF THE INVENTION

Exemplary embodiments of the present invention provide a display apparatus determining a distance of a viewer from the display apparatus.

Exemplary embodiments of the present invention also provide a method of recognizing an air touch using the display apparatus.

Exemplary embodiments of the present invention also provide a method of displaying a three-dimensional (“3D”) image using the display apparatus.

In an exemplary embodiment of a display apparatus according to the present invention, the display apparatus includes a display panel, a first camera, a second camera and a distance determining part. The first camera and the second camera are disposed adjacent to the display panel. The distance determining part determines a position of a body portion of a viewer and a distance of the body portion of the viewer from the display panel based on a first image of the first camera and a second image of the second camera.

In an exemplary embodiment, the distance determining part may include a body detecting part determining the position of the body portion based on the first image and the second image and a distance calculating part calculating the distance of the body portion by comparing the first image and the second image.

In an exemplary embodiment, the distance calculating part may determine that the distance of the body portion from the display panel is relatively long when a distance between a relative position of the body portion in the first image and a relative position of the body portion in the second image is relatively short.

In an exemplary embodiment, a distance between the first and the second cameras is d, an angle of the first camera from an inner scanning boundary to an outer scanning boundary is θ, an angle of the second camera from an inner scanning boundary to an outer scanning boundary is θ, an angle of the body portion inclined from the inner scanning boundary of the first camera is θ1, an angle of the body portion inclined from the inner scanning boundary of the second camera is θ2, a distance of the body portion from a line connecting the first and the second cameras is

$$l = d \times ( \frac{tan ( \frac{π - θ}{2} + θ 1 ) \times tan ( \frac{π - θ}{2} + θ 2 )}{tan ( \frac{π - θ}{2} + θ 1 ) + tan ( \frac{π - θ}{2} + θ 2 )} ) .$$

In an exemplary embodiment, the distance determining part may determine the distance of the body portion from the display panel when the body portion is disposed in a region of interest.

In an exemplary embodiment, the distance determining part may increase the region of interest in a predetermined value and may detect the body portion when the body portion is not disposed in the region of interest.

In an exemplary embodiment, the distance determining part may further include a touch recognizing part recognizing an air touch when the distance of the body portion from the display panel is less than a reference distance.

In an exemplary embodiment, the body portion may be a hand of the viewer.

In an exemplary embodiment, the display apparatus may further include an optical element disposed on the display panel and converting a two-dimensional image displayed on the display panel into a three-dimensional image.

In an exemplary embodiment, the optical element may be a barrier module selectively transmitting light.

In an exemplary embodiment, the display apparatus may further include an optical element driver adjusting that a gap between adjacent transmitting portions of the optical element increases as the body portion of the viewer get farther from the display panel.

In an exemplary embodiment, the body portion may be a face of the viewer.

In an exemplary embodiment of a method of recognizing an air touch, the method includes scanning a first image using a first camera disposed adjacent to a display panel, scanning a second image using a second camera disposed adjacent to the display panel, determining a position of a body portion of a viewer and a distance of the body portion of the viewer from the display panel based on the first image and the second image and recognizing the air touch when the distance of the body portion from the display panel is less than a reference distance.

In an exemplary embodiment, the determining the distance of the body portion from the display panel may include determining that the distance of the body portion from the display panel is relatively long when a distance between a relative position of the body portion in the first image and a relative position of the body portion in the second image is relatively short.

In an exemplary embodiment, a distance between the first and the second cameras is d, an angle of the first camera from an inner scanning boundary to an outer scanning boundary is θ, an angle of the second camera from an inner scanning boundary to an outer scanning boundary is θ, an angle of the body portion inclined from the inner scanning boundary of the first camera is θ1, an angle of the body portion inclined from the inner scanning boundary of the second camera is θ2, a distance of the body portion from a line connecting the first and the second cameras is

$$l = d \times ( \frac{tan ( \frac{π - θ}{2} + θ 1 ) \times tan ( \frac{π - θ}{2} + θ 2 )}{tan ( \frac{π - θ}{2} + θ 1 ) + tan ( \frac{π - θ}{2} + θ 2 )} ) .$$

In an exemplary embodiment, the distance of the body portion from the display panel may be determined when the body portion is disposed in a region of interest.

In an exemplary embodiment, the region of interest may be increased in a predetermined value and the body portion may be detected when the body portion is not disposed in the region of interest.

In an exemplary embodiment of a method of displaying a 3D image, the method includes scanning a first image using a first camera disposed adjacent to a display panel, scanning a second image using a second camera disposed adjacent to the display panel, determining a position of a body portion of a viewer and a distance of the body portion of the viewer from the display panel based on the first image and the second image and adjusting a characteristic of an optical element disposed on the display panel according to the distance of the body portion from the display panel.

In an exemplary embodiment, optical element may be a barrier module selectively transmitting light.

In an exemplary embodiment, adjusting the characteristic of the optical element may include increasing a gap between adjacent transmitting portions of the optical element as according to a distance of the body portion of the viewer from the display panel.

According to the display apparatus, the distance of the viewer from the display panel may be determined accurately. Thus, the display apparatus may recognize the air touch. In addition, a display quality of the 3D image may be improved.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a block diagram illustrating a display apparatus according to an exemplary embodiment of the present invention;

FIG. 2 is a plan view illustrating a display panel of FIG. 1, a first camera and a second camera.

FIG. 3 is a detailed block diagram illustrating the display apparatus of FIG. 1;

FIG. 4 is a block diagram illustrating a distance determining part of FIG. 1;

FIG. 5 is a conceptual diagram illustrating a method of determining a distance of a body portion of a viewer using a distance calculating part of FIG. 4;

FIG. 6A is a first image displayed at a displaying part of the first camera of FIG. 5;

FIG. 6B is a second image displayed at a displaying part of the second camera of FIG. 5;

FIG. 7 is a conceptual diagram illustrating a method of determining the distance of the body portion of the viewer using the distance calculating part of FIG. 4;

FIG. 8A is a first image displayed at a displaying part of the first camera of FIG. 7;

FIG. 8B is a second image displayed at a displaying part of the second camera of FIG. 7;

FIG. 9 is a conceptual diagram illustrating a method of recognizing an air touch using the display apparatus of FIG. 1;

FIG. 10 is a block diagram illustrating a display apparatus according to an exemplary embodiment of the present invention;

FIG. 11 is a plan view illustrating an optical element of FIG. 10;

FIG. 12 is a block diagram illustrating a distance determining part of FIG. 10;

FIG. 13A is a plan view illustrating a state of the optical element of FIG. 10 when the body portion of the viewer is disposed relatively close to the display panel of FIG. 10; and

FIG. 13B is a plan view illustrating the state of the optical element of FIG. 10 when the body portion of the viewer is disposed relatively far from the display panel of FIG. 10.

### DETAILED DESCRIPTION OF THE INVENTION

Hereinafter, exemplary embodiments of the present invention will be described in further detail with reference to the accompanying drawings.

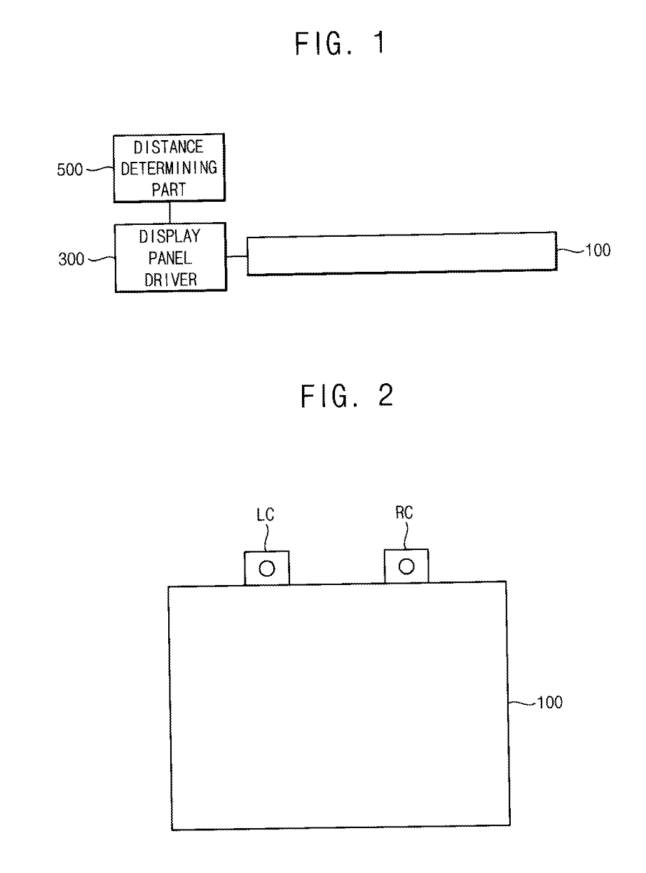

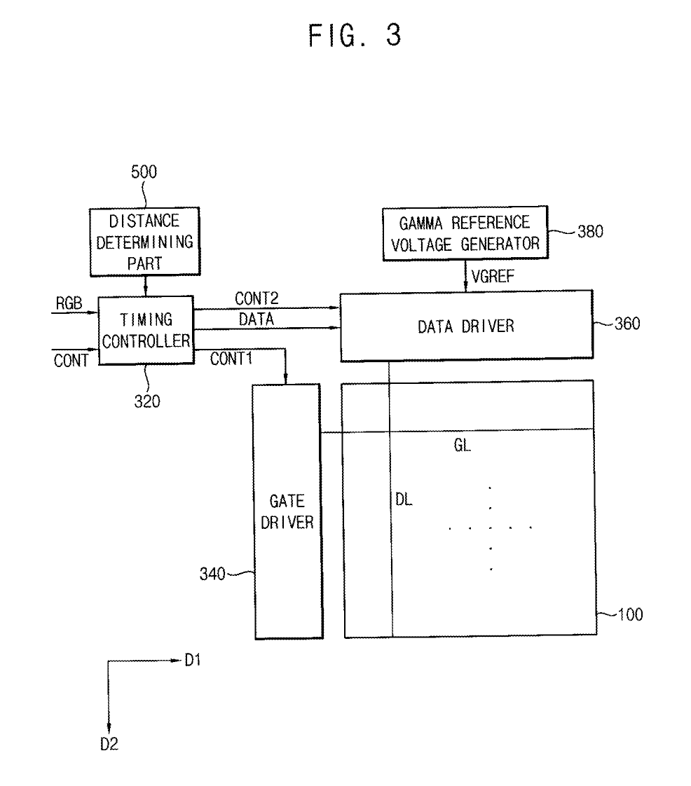

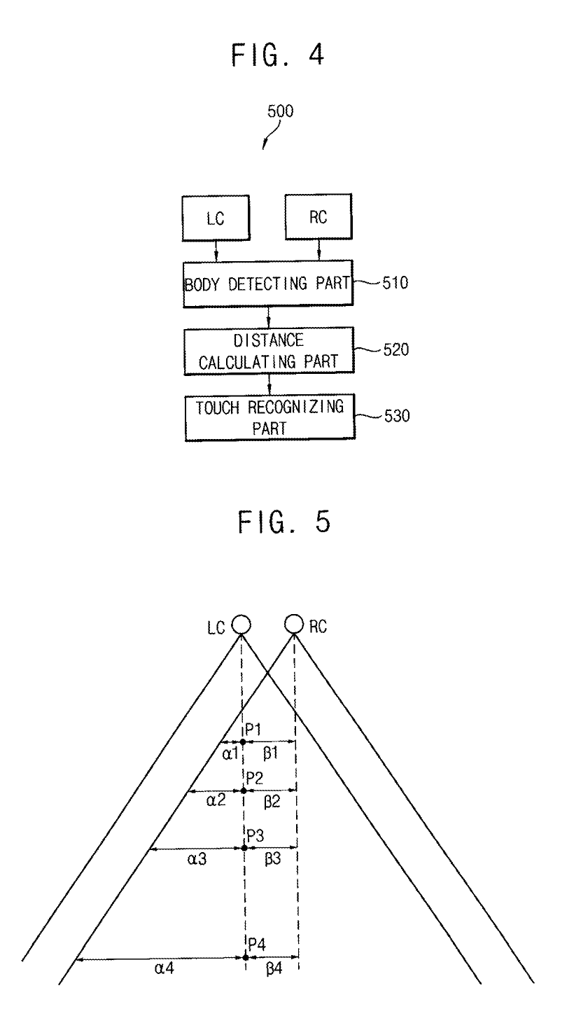

FIG. 1 is a block diagram illustrating a display apparatus according to an exemplary embodiment of the present invention. FIG. 2 is a plan view illustrating a display panel 100 of FIG. 1, a first camera LC and a second camera RC. FIG. 3 is a detailed block diagram illustrating the display apparatus of FIG. 1. FIG. 4 is a block diagram illustrating a distance determining part 500 of FIG. 1.

Referring to FIGS. 1 to 4, the display apparatus includes a display panel 100, a first camera LC, a second camera RC, a display panel driver 300 and a distance determining part 500.

The display panel 100 displays an image. The display panel 100 may include a first substrate, a second substrate facing the first substrate and a liquid crystal layer disposed between the first and second substrates.

The display panel 100 includes a plurality of pixels. The pixels may include a red subpixel, a green subpixel and a blue subpixel.

The display panel 100 includes a plurality of gate lines GL and a plurality of data lines DL. The subpixels are connected to one of the gate lines GL and the data lines DL. The gate lines GL extend in a first direction D1. The date lines DL extend in a second direction D2 crossing the first direction D1.

Each subpixel includes a switching element and a liquid crystal capacitor electrically connected to the switching element. The subpixel may further include a storage capacitor. The subpixels are disposed in a matrix form. The switching element may be a thin film transistor.

The gate lines GL, the data lines DL, pixel electrodes and storage electrodes may be disposed on the first substrate. A common electrode may be disposed on the second substrate.

The first camera LC and the second camera RC are disposed adjacent to the display panel 100. The first camera LC and the second camera RC may be disposed on a substantially the same plane as the display panel 100.

For example, the first camera LC and the second camera RC may be disposed at an upper portion of the display panel 100. Alternatively, the first camera LC and the second camera RC may be disposed at a lower portion of the display panel 100.

For example, the first camera LC and the second camera RC may be disposed at a bezel portion of the display panel 100. Alternatively, the first camera LC and the second camera RC may be protruded from the bezel portion of the display panel 100.

The first camera LC scans a first image. The second camera RC scans a second image. The first camera LC transmits the first image to the distance determining part 500. The second camera RC transmits the second image to the distance determining part 500.

The display panel driver 300 is connected to the display panel 100 to drive the display panel 100. The display panel driver 300 includes a timing controller 320, a gate driver 340, a data driver 360 and a gamma reference voltage generator 380.

The timing controller 320 receives input image data RGB and an input control signal CONT from an external apparatus. The input image data RGB may include red image data R, green image data G and blue image data B. The input control signal CONT may include a master clock signal, a data enable signal, a vertical synchronizing signal and a horizontal synchronizing signal.

The timing controller 320 may receive a position of a body portion of a viewer and a distance of the body portion of the viewer from the display panel 100 from the distance determining part 500. The timing controller 320 may receive an air touch generating event from the distance determining part 500.

The timing controller 320 generates a first control signal CONT1, a second control signal CONT2 and a data signal DATA based on the input image data RGB and the input control signal CONT.

The timing controller 320 generates the first control signal CONT1 to control a driving timing of the gate driver 340 based on the input control signal CONT, and outputs the first control signal CONT1 to the gate driver 340. The first control signal CONT1 may include a vertical start signal and a gate clock signal.

The timing controller 320 generates the second control signal CONT2 to control a driving timing of the data driver 360 based on the input control signal CONT, and outputs the second control signal CONT2 to the data driver 360. The second control signal CONT2 may include a horizontal start signal and a load signal.

The timing controller 320 generates the data signal DATA based on the input image data RGB, and outputs the data signal DATA to the data driver 360.

The gate driver 340 receives the first control signal CONT1 from the timing controller 320. The gate driver 340 generates gate signals for driving the gate lines GL in response to the first control signal CONT1. The gate driver 340 sequentially outputs the gate signals to the gate lines GL.

The gamma reference voltage generator 380 generates a gamma reference voltage VGREF. The gamma reference voltage generator 380 provides the gamma reference voltage VGREF to the data driver 360. The gamma reference voltages VGREF have values corresponding to the data signal DATA. The gamma reference voltage generator 380 may be disposed in the data driver 360.

The data driver 360 receives the second control signal CONT2 and the data signal DATA from the timing controller 320. The data driver 360 receives the gamma reference voltage VGREF from the gamma reference voltage generator 380.

The data driver 360 converts the data signal DATA into data voltages having analog types using the gamma reference voltage VGREF. The data driver 360 outputs the data voltages to the data lines DL.

The distance determining part 500 determines the position of the body portion of the viewer and the distance of the body portion from the display panel 100 based on the first image from the first camera LC and the second image from the second camera RC. For example, the body portion of the viewer may be a face, an eye or a hand

The distance determining part 500 is connected to the display panel driver 300. The distance determining part 500 outputs the position of the body portion and the distance of the body portion from the display panel 100 to the display panel driver 300. The distance determining part 500 may output the air touch generating event to the display panel driver 300.

The distance determining part 500 determines the distance of the body portion from the display panel 100 when the body portion is disposed in a region of interest. The region of interest may be predetermined. The region of interest may be set by a user. When the body portion is not disposed in the region of interest, the distance determining part 500 may increase the region of interest in a predetermined value and may detect the body portion.

The distance determining part 500 includes a body detecting part 510 and a distance calculating part 520. The distance determining part 500 may further include a touch recognizing part 530.

The body detecting part 510 receives the first image from the first camera LC and the second image from the second camera RC.

The body detecting part 510 determines the position of the body portion based on the first image and the second image. The body detecting part 510 may determine the position of the body portion using a data base storing data modeling characteristics of human body portions. For example, the body detecting part 510 may detect the body portion in a two-dimensional plane.

The distance calculating part 520 receives a position of the body portion based on the first image and a position of the body portion based on the second image.

The distance calculating part 520 compares the position of the body portion based on the first image and the position of the body portion based on the second image to calculate the distance of the body portion from the display panel 100. A method of calculating the distance of the body portion from the display panel 100 using the distance calculating part 520 is explained in detail referring to FIGS. 5 to 8B.

The touch recognizing part 530 receives the distance of the body portion from the display panel 100 from the distance calculating part 520.

The touch recognizing part 530 recognizes an air touch when the distance of the body portion from the display panel 100 is less than a reference distance. A method of recognizing the air touch using the touch recognizing part 530 is explained in detail referring to FIG. 9.

For example, the touch recognizing part 530 may recognize the air touch using the position of a hand of the viewer. Alternatively, the touch recognizing part 530 may recognize the air touch using positions of other body portions or a tool hold in the viewer's hand.

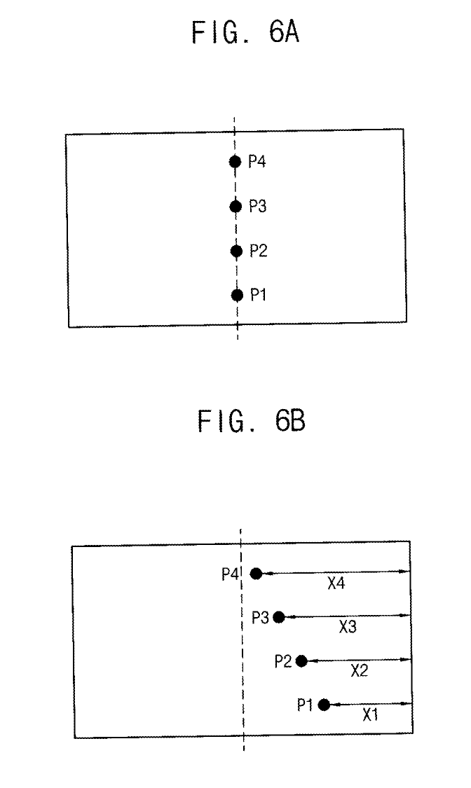

FIG. 5 is a conceptual diagram illustrating a method of determining the distance of the body portion of the viewer using the distance calculating part 520 of FIG. 4. FIG. 6A is a first image displayed at a displaying part of the first camera LC of FIG. 5. FIG. 6B is a second image displayed at a displaying part of the second camera RC of FIG. 5;

Referring to FIGS. 5, 6A and 6B, exemplary body portions are disposed at a first position P1, a second position P2, a third position P3 and a fourth position P4.

The first to fourth positions P1 to P4 are sequentially disposed from the first camera LC along a central line of the first camera LC. In FIG. 6A, the first to fourth positions P1 to P4 are sequentially disposed in a central portion of the first camera LC.

When observing the first to the fourth positions P1 to P4 at the second camera RC, the first position P1 is disposed at an outermost side portion of the second image and the fourth position P4 is disposed at an innermost side portion of the second image. The first position P1 is disposed close to a right side of the second image. The fourth position P4 is disposed close to a central portion of the second image.

In the second image, a distance between the body portion and the right side of the second image according to the display is defined as X and a distance between the body portion and a central line of the second image according to the display is defined as Y. Distances between the first to the fourth portions P1, P2, P3 and P4 and the right side of the second image are respectively defined as X1, X2, X3 and X4, distances between the first to the fourth portions P1, P2, P3 and P4 and the central line of the second image are respectively defined as Y1, Y2, Y3 and Y4.

X and Y are determined as a ratio between a distance a of the body portion from the right side of the second image and a distance 3 of the body portion from a central portion of the second camera RC. X and Y are determined by following Equation 1 and Equation 2.

$$\begin{matrix}X = \frac{α}{α + β} & [ Equation 1 ] \\ Y = \frac{β}{α + β} & [ Equation 2 ]\end{matrix}$$

In the present exemplary embodiment, when α1 and β1 correspond to the first position P1, α2 and β2 correspond to the second position P2, α3 and β3 correspond to the third position P3 and α4 and β4 correspond to the fourth position P4, α1<α2<α3<α4 and β1=β2=β3=β4. Thus, X1<X2<X3<X4 and Y1>Y2>Y3>Y4.

As shown in FIGS. 6A and 6B and Equations 1 and 2, the first position P1 which is the closest to the display panel 100 has a relatively great difference between the first image and the second image. The fourth position P4 which are the farthest from the display panel 100 has a relatively little difference between the first image and the second image.

As a result, when the distance between a relative position of the body portion in the first image and a relative position of the body portion in the second image is relatively little, the distance calculating part 520 determines that the distance of the body portion from the display panel 100 is relatively great.

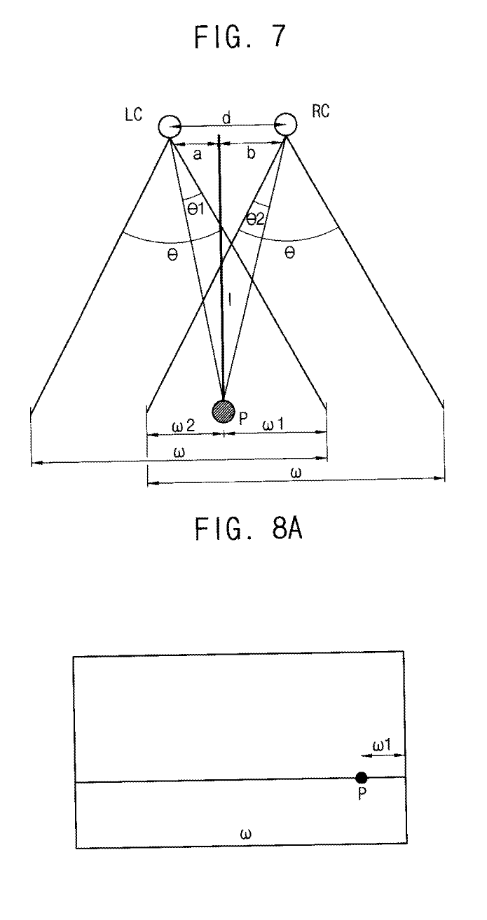

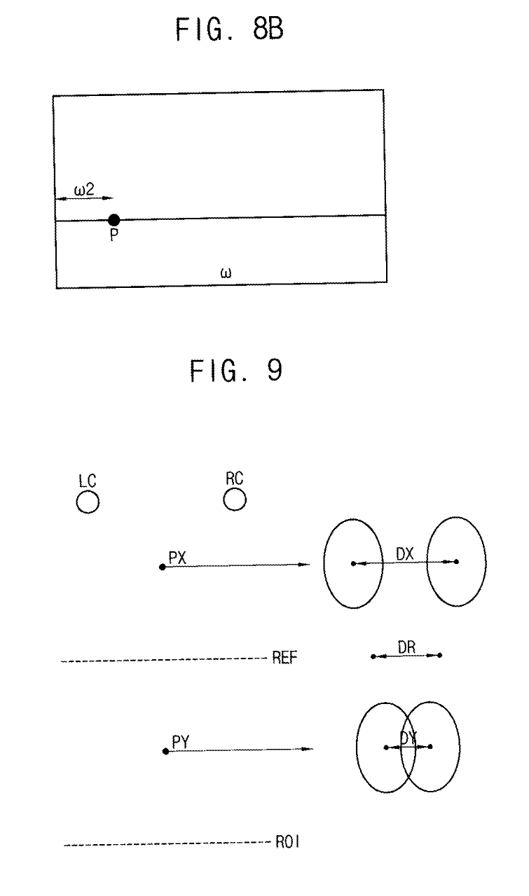

FIG. 7 is a conceptual diagram illustrating a method of determining the distance of the body portion of the viewer using the distance calculating part 520 of FIG. 4. FIG. 8A is a first image displayed at a displaying part of the first camera LC of FIG. 7. FIG. 8B is a second image displayed at a displaying part of the second camera RC of FIG. 7.

Referring to FIGS. 7, 8A and 8B, a distance of the body portion P from a line connecting the first camera LC and the second camera RC is l. l is substantially the same as the distance of the body portion from the display panel 100.

A distance between the first camera LC and the second camera RC is d. When drawing a vertical line from the body portion P to the line connecting the first and second camera LC and RC, a distance from the first camera LC to the perpendicular line is a, and a distance from the second camera RC to the perpendicular line is b.

An angle of the first camera LC from the inner scanning boundary to the outer scanning boundary is θ and an angle of the second camera RC from the inner scanning boundary to the outer scanning boundary is θ. An angle of the body portion P inclined from the inner scanning boundary of the first camera LC is θ1 and an angle of the body portion P inclined from the inner scanning boundary of the second camera RC is θ2.

In FIG. 8A, a ratio between θ and θ1 is substantially equal to a ratio between ω which is a horizontal length of the first image and ω1 which is a horizontal length of the body portion P from an inner vertical side of the first image. Thus, θ1 is determined by following Equation 3.

$$θ 1 = \frac{ω 1 \times θ}{ω} \qquad [ Equation 3 ]$$

In a similar manner, in FIG. 8B, a ratio between θ and θ2 is substantially equal to a ratio between ω which is a horizontal length of the second image and ω2 which is a horizontal length of the body portion P from an inner vertical side of the second image. Thus, θ2 is determined by following Equation 4.

$$θ 2 = \frac{ω 2 \times θ}{ω} \qquad [ Equation 4 ]$$

The distance d between the first and second cameras LC and RC is a+b so that the distance l of the body portion P from the line connecting the first and second cameras LC and RC is determined by following Equation 5.

$$l = d \times ( \frac{tan ( \frac{π - θ}{2} + θ 1 ) \times tan ( \frac{π - θ}{2} + θ 2 )}{tan ( \frac{π - θ}{2} + θ 1 ) + tan ( \frac{π - θ}{2} + θ 2 )} ) \qquad [ Equation 5 ]$$

FIG. 9 is a conceptual diagram illustrating a method of recognizing an air touch using the display apparatus of FIG. 1.

Referring to FIGS. 1 to 4 and 9, the distance determining part 500 further includes the touch recognizing part 530. The touch recognizing part 530 recognizes the air touch when the distance of the body portion from the display panel 100 is less than a reference distance REF from the display panel 100.

The touch recognizing part 530 recognizes the air touch when a distance between an image of the body portion in the first image scanned by the first camera LC and an image of the body portion in the second image scanned by the second camera RC is equal to or greater than a reference distance DR.

In contrast, the touch recognizing part 530 does not recognize the air touch when the distance between an image of the body portion in the first image scanned by the first camera LC and an image of the body portion in the second image scanned by the second camera RC is less than the reference distance DR.

For example, when the body portion is disposed in a position of PX, a distance DX between an image of the body portion in the first image and an image of the body portion in the second image is greater than the reference distance DR so that the touch recognizing part 530 recognizes the air touch.

For example, when the body portion is disposed in a position of PY, a distance DY between an image of the body portion in the first image and an image of the body portion in the second image is less than the reference distance DR so that the touch recognizing part 530 does not recognize the air touch.

The touch recognizing part 530 may determine that the air touch is generated or not when the body portion is disposed in the region of interest.

According to the present exemplary embodiment, the display apparatus may determine the distance of the body portion of the viewer from the display panel 100 accurately. Thus, the air touch may be recognized using the display apparatus.

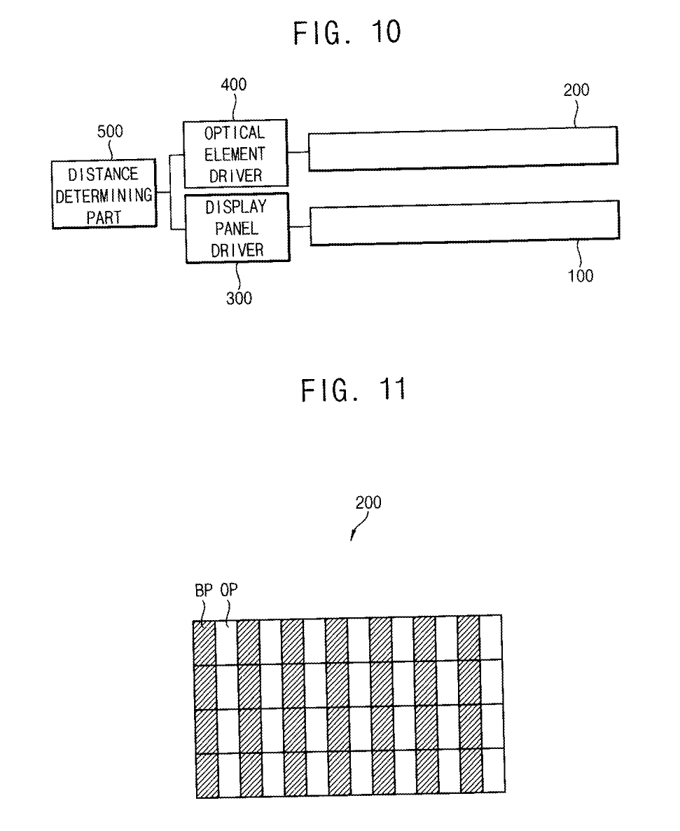

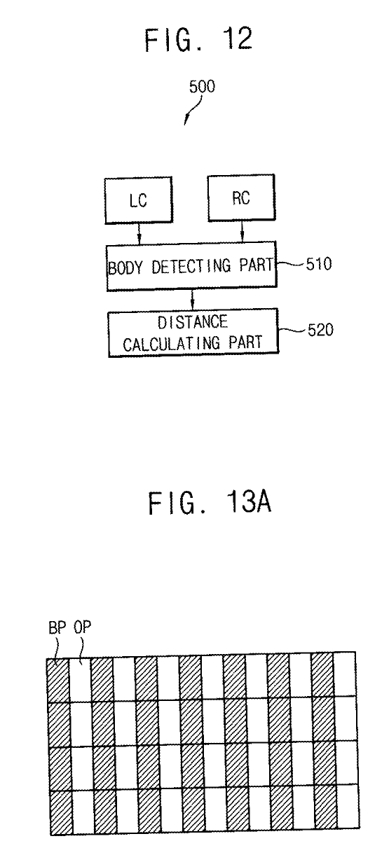

FIG. 10 is a block diagram illustrating a display apparatus according to an exemplary embodiment of the present invention. FIG. 11 is a plan view illustrating an optical element 200 of FIG. 10. FIG. 12 is a block diagram illustrating a distance determining part 500 of FIG. 10.

A display apparatus according to the present exemplary embodiment is substantially the same as the display apparatus of the previous exemplary embodiment explained referring to FIGS. 1 to 9 except that the display apparatus further includes an optical element and an optical element driver to display the 3D image. Thus, the same reference numerals will be used to refer to the same or like parts as those described in the previous exemplary embodiment of FIGS. 1 to 9 and any repetitive explanation concerning the above elements will be omitted.

Referring to FIGS. 2, 3 and 10 to 12, the display apparatus includes a display panel 100, an optical element 200, a first camera LC, a second camera RC, a display panel driver 300, an optical element driver 400 and a distance determining pan 500.

The display panel 100 displays an image. The display panel 100 may include a first substrate, a second substrate facing the first substrate and a liquid crystal layer disposed between the first and second substrates.

The optical element 200 is disposed on the display panel 100. The optical element 200 converts the 2D image on the display panel 100 into the 3D image.

In the present exemplary embodiment, the optical element 200 may be a barrier module selectively transmitting light. For example, the optical element 200 includes a blocking portion BP and a transmitting portion OP which are alternately disposed with each other. The optical element 200 selectively blocks the image on the subpixel of the display panel 100 so that the image on the display panel 100 is transmitted to a plurality of viewpoints. The blocking portion BP and the transmitting portion OP are alternately disposed in the first direction D1. The blocking portion BP and the transmitting portion OP extend in the second direction D2. Alternatively, the optical element 200 may be a lens module including a plurality of lenticular lenses.

The optical element 200 may include a plurality of first electrodes extending in the first direction D1 and a plurality of second electrodes extending in the second direction D2. The optical element 200 may have a matrix form by the first electrodes and the second electrodes crossing each other. Alternatively, the optical element 200 may include a plurality of second electrodes extending in the second direction D2 so that the optical element 200 may have a stripe form by the second electrodes.

For example, the optical element 200 may be the barrier module which is operated according to the driving mode including the 2D mode and the 3D mode. For example, the optical element 200 may be a liquid crystal barrier module. The barrier module is turned on or off in response to the driving mode. For example, the barrier module is turned off in the 2D mode so that the display apparatus displays the 2D image. The barrier module is turned on in the 3D mode so that the display apparatus displays the 3D image.

The barrier module includes a first barrier substrate, a second barrier substrate facing the first barrier substrate and a barrier liquid crystal layer disposed between the first and second barrier substrates.

The first camera LC scans a first image. The second camera RC scans a second image. The first camera LC transmits the first image to the distance determining part 500. The second camera RC transmits the second image to the distance determining part 500.

The display panel driver 300 is connected to the display panel 100 to drive the display panel 100. The display panel driver 300 includes a timing controller 320, a gate driver 340, a data driver 360 and a gamma reference voltage generator 380.

The display panel driver 300 may further include a frame rate converter disposed prior to the timing controller 320 and converting a frame rate of the input image data RGB.

The optical element driver 400 is connected to the optical element 200 to drive the optical element 200.

The distance determining part 500 determines the position of the body portion of the viewer and the distance of the body portion from the display panel 100 based on the first image from the first camera LC and the second image from the second camera RC.

The distance determining part 500 is connected to the display panel driver 300. The distance determining part 500 may output the position of the body portion and the distance of the body portion from the display panel 100 to the display panel driver 300. The distance determining part 500 may output the position of the body portion and the distance of the body portion from the display panel 100 to the optical element driver 400.

The distance determining part 500 includes a body detecting part 510 and a distance calculating part 520. Although not shown in figures, the distance determining part 500 may further include a touch recognizing part 530 in FIG. 4.

The optical element driver 400 adjusts a characteristic of the optical element 200 on the display panel 100 according to the distance of the body portion from the display panel 100.

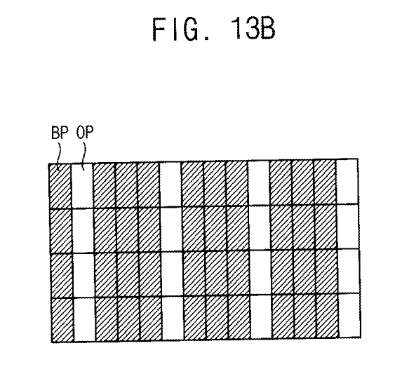

FIG. 13A is a plan view illustrating a state of the optical element 200 of FIG. 10 when the body portion of the viewer is disposed relatively close to the display panel 100 of FIG. 10. FIG. 13B is a plan view illustrating the state of the optical element 200 of FIG. 10 when the body portion of the viewer is disposed relatively far from the display panel 100 of FIG. 10.

Referring to FIGS. 10 to 12, 13A and 13B, as the body portion of the viewer get closer to the display panel 100, the optical element driver 400 may adjusts that a gap between the adjacent transmitting portions OP of the optical element 200 decreases.

In contrast, as the body portion of the viewer get farther from the display panel 100, the optical element driver 400 may adjusts that a gap between the adjacent transmitting portions OP of the optical element 200 increases.

In the present exemplary embodiment, the body portion of the viewer may be a face. Alternatively, the body portion of the viewer may be an eye.

According to the present exemplary embodiment, the display apparatus may determine the distance of the body portion of the viewer from the display panel 100 accurately. The gap between the transmitting portions OP of the optical element 200 is adjusted according to the distance of the body portion of the viewer from the display panel 200 so that a crosstalk, which is a left image is shown to a right eye of the viewer or a right image is shown to a left eye of the viewer, may be prevented. Thus, a display quality of the 3D image may be improved.

As explained above, according to the display apparatus, the distance of the body portion of the viewer from the display panel may be determined accurately. Thus, the display apparatus may recognize the air touch. In addition, a display quality of the 3D image may be improved.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A display apparatus comprising:
a display panel;
a first camera and a second camera disposed adjacent to the display panel; and
a distance determining part determining a position of a body portion of a viewer and a distance of the body portion of the viewer from the display panel based on a first image of the first camera and a second image of the second camera.

2. The display apparatus of claim 1, wherein the distance determining part comprises:
a body detecting part determining the position of the body portion based on the first image and the second image; and
a distance calculating part calculating the distance of the body portion by comparing the first image and the second image.

3. The display apparatus of claim 2, wherein the distance calculating part determines that the distance of the body portion from the display panel is relatively long when a distance between a relative position of the body portion in the first image and a relative position of the body portion in the second image is relatively short.

4. The display apparatus of claim 3, wherein a distance between the first and the second cameras is d, an angle of the first camera from an inner scanning boundary to an outer scanning boundary is θ, an angle of the second camera from an inner scanning boundary to an outer scanning boundary is θ, an angle of the body portion inclined from the inner scanning boundary of the first camera is θ1, an angle of the body portion inclined from the inner scanning boundary of the second camera is θ2, a distance of the body portion from a line connecting the first and the second cameras is l,
$$l = d \times ( \frac{tan ( \frac{π - θ}{2} + θ 1 ) \times tan ( \frac{π - θ}{2} + θ 2 )}{tan ( \frac{π - θ}{2} + θ 1 ) + tan ( \frac{π - θ}{2} + θ 2 )} ) .$$

5. The display apparatus of claim 2, wherein the distance determining part determines the distance of the body portion from the display panel when the body portion is disposed in a region of interest.

6. The display apparatus of claim 5, wherein the distance determining part increases the region of interest in a predetermined value and detects the body portion when the body portion is not disposed in the region of interest.

7. The display apparatus of claim 2, wherein the distance determining part further includes a touch recognizing part recognizing an air touch when the distance of the body portion from the display panel is less than a reference distance.

8. The display apparatus of claim 7, wherein the body portion is a hand of the viewer.

9. The display apparatus of claim 2, further comprising an optical element disposed on the display panel and converting a two-dimensional image displayed on the display panel into a three-dimensional image.

10. The display apparatus of claim 9, wherein the optical element is a barrier module selectively transmitting light.

11. The display apparatus of claim 10, further comprising an optical element driver adjusting that a gap between adjacent transmitting portions of the optical element increases as the body portion of the viewer get farther from the display panel.

12. The display apparatus of claim 11, wherein the body portion is a face of the viewer.

13. A method of recognizing an air touch, the method comprising:
scanning a first image using a first camera disposed adjacent to a display panel;
scanning a second image using a second camera disposed adjacent to the display panel;
determining a position of a body portion of a viewer and a distance of the body portion of the viewer from the display panel based on the first image and the second image; and
recognizing the air touch when the distance of the body portion from the display panel is less than a reference distance.

14. The method of claim 13, wherein the determining the distance of the body portion from the display panel comprising:
determining that the distance of the body portion from the display panel is relatively long when a distance between a relative position of the body portion in the first image and a relative position of the body portion in the second image is relatively short.

15. The method of claim 14, wherein a distance between the first and the second cameras is d, an angle of the first camera from an inner scanning boundary to an outer scanning boundary is θ, an angle of the second camera from an inner scanning boundary to an outer scanning boundary is θ, an angle of the body portion inclined from the inner scanning boundary of the first camera is θ1, an angle of the body portion inclined from the inner scanning boundary of the second camera is θ2, a distance of the body portion from a line connecting the first and the second cameras is l,
$$l = d \times ( \frac{tan ( \frac{π - θ}{2} + θ 1 ) \times tan ( \frac{π - θ}{2} + θ 2 )}{tan ( \frac{π - θ}{2} + θ 1 ) + tan ( \frac{π - θ}{2} + θ 2 )} ) .$$

16. The method of claim 13, wherein the distance of the body portion from the display panel is determined when the body portion is disposed in a region of interest.

17. The method of claim 16, wherein the region of interest is increased in a predetermined value and the body portion is detected when the body portion is not disposed in the region of interest.

18. A method of displaying a three-dimensional image, the method comprising:
scanning a first image using a first camera disposed adjacent to a display panel;
scanning a second image using a second camera disposed adjacent to the display panel;
determining a position of a body portion of a viewer and a distance of the body portion of the viewer from the display panel based on the first image and the second image; and
adjusting a characteristic of an optical element disposed on the display panel according to the distance of the body portion from the display panel.

19. The method of claim 18, wherein the optical element is a barrier module selectively transmitting light.

20. The method of claim 19, wherein adjusting the characteristic of the optical element comprising:
increasing a gap between adjacent transmitting portions of the optical element as according to a distance of the body portion of the viewer from the display panel.
